(19) United States
(12) Patent Application Publication
(10) Pub. No.: US 2012/0240417 A1
(43) Pub. Date: Sep. 27, 2012

(54) Glass breaking cap for flashlights and batons

(76) Inventor: Mei-Huey Lee, New Taipie City (TW)

(21) Appl. No.: 13/067,038

(22) Filed: May 4, 2011

(30) Foreign Application Priority Data
Mar. 25, 2011 (TW) 100205387

(51) Int. Cl. A62B 3/00; B26F 1/32

(52) U.S. Cl. 30/366

(57) ABSTRACT

The present invention relates to a glass breaking cap for a flashlight or baton, which has a bottom portion corresponding in configuration to and connectable with an end of the flashlight or baton, a top portion tapering upward such that the cap has a cross section whose two adjacent upper sides form a first included angle greater than 140 degrees, and a striking portion extending upward from a central area of the top portion. The striking portion is conical and has a cross section whose two adjacent upper sides form a second included angle less than 100 degrees. Thus, when the cap is connected to the end of the flashlight or baton and struck against a glass barrier, the striking portion creates a breaking point on the glass barrier, thus allowing the top portion to further crush the internal cohesion of the glass barrier and thereby break the glass barrier.

### FIELD OF THE INVENTION

The present invention relates to a cap of a flashlight or baton, more particularly to a glass breaking cap applicable to a flashlight or baton and configured for striking a glass barrier (e.g., a car window or a glass door).

### BACKGROUND OF THE INVENTION

Made essentially of silica (SiO₂), glass is a transparent and gas-impermeable material featuring hardness as well as light permeability and is therefore frequently used in buildings, transportation vehicles, containers, and so forth. According to archaeological surveys, the first colorless transparent glass bottles were made as early as 200 BC. However, glass forming methods such as pressing, blowing, and drawing were not fully developed until the 19^{th} century. Since then, and thanks to the various glass processing techniques such as grinding, carving, and eroding, glass has been a very common material for industrial use. Now in the 21^{st} century, where the glassmaking technology and industry are highly mature, new types of glass are brought into the market on a regular basis. Some notable examples of such newly developed glass materials are tempered glass, thermal glass, low-expansion glass, laminated glass, photosensitive glass, foam glass, glass fabric, and clear UV/IR-blocking glass. While these new glass materials contribute to a higher living standard, they can also be a hazard to safety without our knowing it. For instance, glass barriers of all kinds (e.g., car windows and glass doors) tend to hinder people's escape from car accidents, indoor fire accidents, or other accidents that take place in glass-enclosed spaces, for it is extremely difficult to break the glass barriers rapidly without a proper tool. Even if they are successfully broken, the broken glass pieces are sharp and hard to remove, which also delays evacuation or rescue operations performed by law enforcement or emergency personnel (e.g., the police or firefighters).

Although specially designed glass breaking devices are currently commercially available to facilitate escape for life, most of them are intended exclusively for breaking glass. As it is practically impossible for the general public to carry these glass breakers around at all times, merely the search for such a device could take a long time, which is fatal to evacuation or rescue operations, where every second counts. Therefore, a glass breaking cap was devised for being affixed to a flashlight or baton, as disclosed in U.S. Pat. No. 7,887,211 and shown in FIGS. 1 and 2 of the present application. The cap 10 in FIGS. 1 and 2 corresponds in configuration to and can be connected with an end of a flashlight or baton 11. More specifically, the top portion of the cap 10 tapers upward and forms as a striking portion 101. The striking portion 101 is conical and has a cross section whose two adjacent upper sides form an included angle A. The included angle A ranges between 106 and 136 degrees so that the tip of the striking portion 101 does not protrude excessively from the end of the flashlight or baton 11. This is to prevent the striking portion 101 of the cap 10 from poking or even injuring the user carrying the flashlight or baton 11. Once affixed to the end of the flashlight or baton 11, the cap 10 can be used to break a glass barrier 12. Referring to FIG. 3 in conjunction with FIG. 2, the tip of the striking portion 101 is directed at and struck against the glass barrier 12. As the striking portion 101 interrupts the internal cohesion of the glass barrier 12, a breaking point 121 is formed on the glass barrier 12 and thereby breaks the glass barrier 12. Nevertheless, the cap 10 still has its drawbacks in use, as stated below:

(1) Excessively large impact area: In order to make the flashlight or baton 11 conveniently portable and easy to use, the tip of the striking portion 101 must have an included angle between 106 and 136 degrees. This rather obtuse tip of the striking portion 101, however, results in an excessively large impact area when the cap 10 is struck against the glass barrier 12. Consequently, the force applied by the user to the flashlight or baton 11 fails to concentrate at a single point.

(2) Shallow breaking point: Due to the large-angle tip of the striking portion 101, the breaking point 121 generated by the striking portion 101 striking the glass barrier 12 does not go deep into the glass barrier 12; as a result, the glass breaking effect is limited or even insufficient when it comes to the various new or improved glass materials (e.g., tempered glass and laminated glass) generally used in modern buildings and vehicles. For the sake of safety, these new or improved glass materials are typically tough, impact-resistant, and difficult to shatter; in other words, they cannot be broken without a strong striking force. Take tempered glass for example. Tempered glass features a compressive stress layer on the surface that enhances the internal cohesion of the glass. Hence, when a piece of tempered glass is subjected to impact, the cracks thus generated must extend well into the glass to break the glass effectively. That is to say, it takes more time and effort to break such a new or improved glass material than to break ordinary glass.

Therefore, the issue to be addressed by the present invention is to design a glass breaking cap which not only can be mounted on all kinds of flashlights and batons but also can break glass barriers faster and more effectively than the prior art so that the glass barriers can be rapidly removed in case of an emergency to facilitate rescue operations.

### BRIEF SUMMARY OF THE INVENTION

In view of the fact that the conventional glass breaking cap, when struck against a glass barrier, cannot break the internal cohesion of the glass barrier effectively as a result of the large impact area of the cap, the inventor of the present invention put years of practical experience into extensive research and, after repeated trials, finally succeeded in developing a glass breaking cap for a flashlight or baton. The glass breaking cap disclosed herein allows a user to break the glass barriers encountered in an emergency situation with the minimum possible effort, so as for law enforcement or emergency personnel to carry out rescue operations as rapidly as possible.

It is an object of the present invention to provide a glass breaking cap for use with a flashlight or baton. The glass breaking cap has a bottom surface that corresponds in configuration to and can be connected with an end of the flashlight or baton. A top portion of the glass breaking cap tapers upward such that the glass breaking cap has a cross section whose two adjacent upper sides form a first included angle. With the first included angle being greater than 140 degrees, the top portion of the glass breaking cap forms a first conical projection. Extending upward from a central area of the top portion of the glass breaking cap is a striking portion. The striking portion is conical and has a cross section whose two adjacent upper sides form a second included angle. With the second included angle being less than 100 degrees, the striking portion forms a second conical projection. When the glass breaking cap is connected to the end of the flashlight or baton and struck against a glass barrier, the second conical projection of the glass breaking cap creates a breaking point on the glass barrier, thus allowing the first conical projection to further crush the internal cohesion of the glass barrier and thereby break the glass barrier.

It is another object of the present invention to enhance the capability of the disclosed glass breaking cap to break the glass barrier. As the first included angle of the glass breaking cap is far greater than the second included angle, a third included angle is formed between the top portion and the striking portion of the glass breaking cap. Once the striking portion enters the glass barrier and creates the breaking point, the remaining portion of the force applied by the user to the flashlight or baton is transmitted instantly outward of the breaking point by virtue of the third included angle to further damage the overall structure of the glass barrier. Moreover, due to the upwardly tapering top portion of the glass breaking cap, the reacting force generated by the glass barrier when hit by the glass breaking cap is transmitted along the first conical projection of the glass breaking cap and distributed evenly throughout the glass breaking cap. Thus, not only is the striking portion prevented from deformation, but also the durability of the glass breaking cap is increased.

Yet another object of the present invention is to provide the bottom surface of the glass breaking cap with a first fastener (e.g., a protruding bolt or a threaded bore), wherein the first fastener corresponds in configuration to a second fastener (e.g., a threaded bore or a protruding bolt) provided at the end of the flashlight or baton. With the first fastener, the glass breaking cap can be connected securely to the flashlight or baton to ensure that the force applied by the user to the flashlight or baton is transmitted directly to the glass breaking cap.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 schematically shows a policeman breaking a car window;

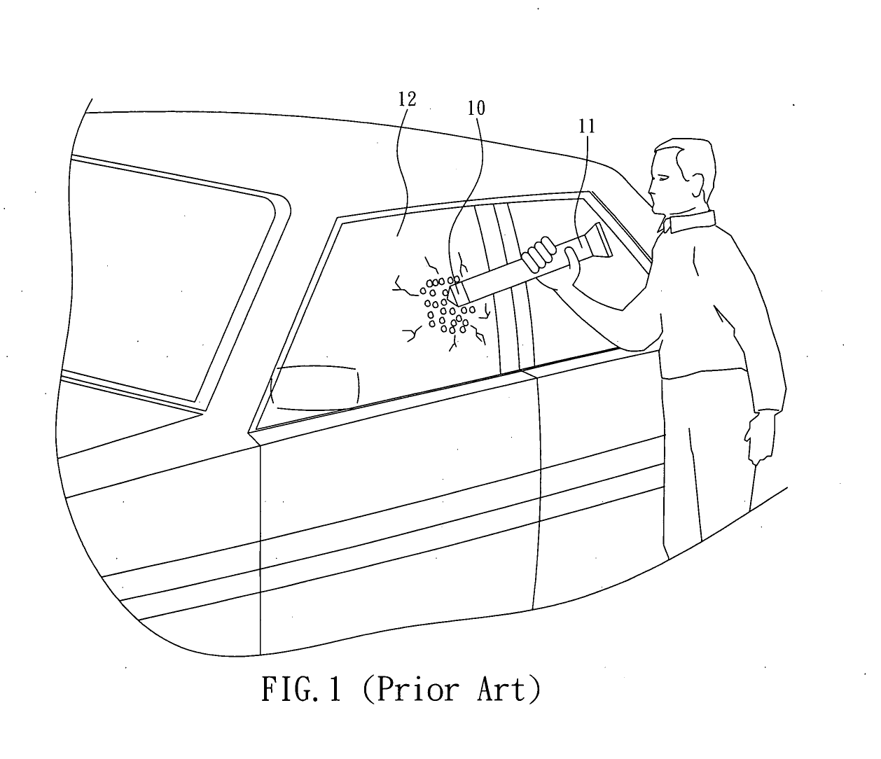

FIG. 2 is a schematic drawing of a conventional glass breaking cap;

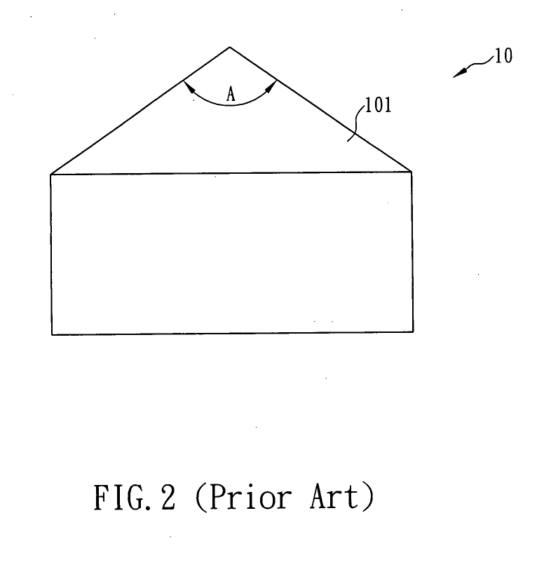

FIG. 3 schematically shows the conventional glass breaking cap striking a glass barrier;

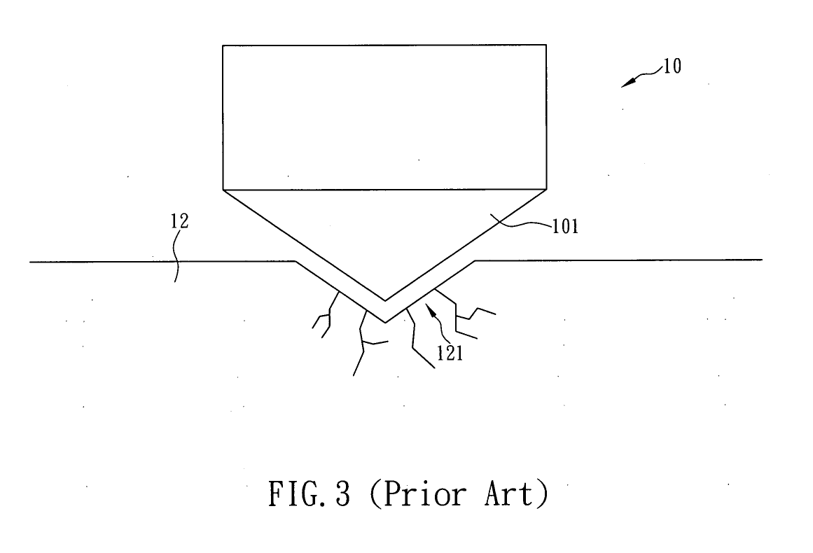

FIG. 4 is a cross-sectional view of a glass breaking cap according to the first preferred embodiment of the present invention;

FIG. 5 schematically shows the glass breaking cap of the present invention striking a glass barrier;

FIG. 6 is a side elevation of a glass breaking cap according to the second preferred embodiment of the present invention; and

FIG. 7 is a partially cut-out side elevation of a glass breaking cap according to the third preferred embodiment of the present invention.

### DETAILED DESCRIPTION OF THE INVENTION

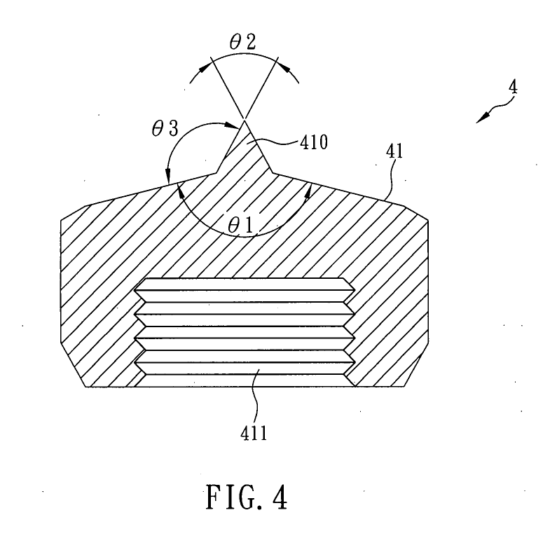

The present invention provides a glass breaking cap applicable to a flashlight or baton and configured for striking a glass barrier (e.g., a car window or a glass door). Please refer to FIG. 4 for a glass breaking cap 4 according to the first preferred embodiment of the present invention. The cap 4 has a bottom surface corresponding in configuration to an end of a flashlight or baton (not shown) so as for the cap 4 to be connected to the end of the flashlight or baton. The cap 4 further has a top portion 41, wherein the top portion 41 tapers upward and forms a first conical projection. The cross section of the top portion 41 has two adjacent lateral sides that form a first included angle θ1. Extending upward from a central area of the top portion 41 of the cap 4 is a striking portion 410. The striking portion 410 is conical and forms a second conical projection. The tip of the striking portion 410 has a cross section whose two adjacent lateral sides form a second included angle θ2. The inventor has found after repeated trials that, by setting the first included angle θ1 greater than 140 degrees, and the second included angle θ2 less than 100 degrees, the force applied by a user to the flashlight or baton will concentrate effectively at the tip of the striking portion 410 of the cap 4, and the striking area of the cap 4 is also minimized, to break the hard surface of the glass barrier.

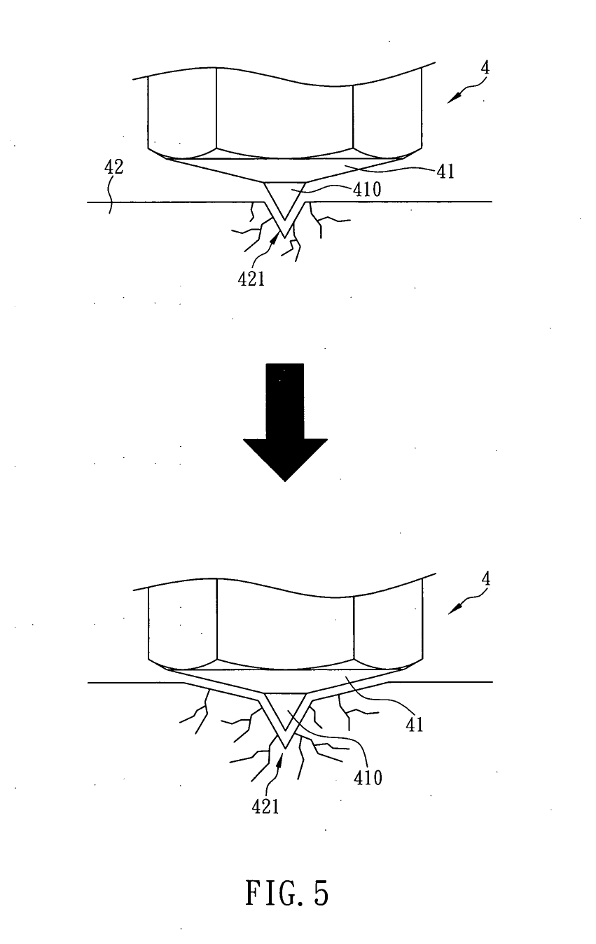

Referring to FIG. 5, when the glass breaking cap 4 is connected to the end of the flashlight or baton and struck against a glass barrier 42, the striking portion 410 of the cap 4 breaks the hard surface of the glass barrier 42 such that the second conical projection of the cap 4 enters the glass barrier 42 by a predetermined depth (i.e., the height of the second conical projection of the cap 4). The predetermined depth is great enough to interrupt the internal cohesion of the glass barrier 42 and create a breaking point 421 on the glass barrier 42. Afterward, the remaining portion of the force applied by the user to the flashlight or baton is transmitted instantly outward of the breaking point 421 through the top portion 41 (i.e., the first conical projection) of the cap 4 to cause damage to the overall structure of the glass barrier 42.

Hence, referring to FIGS. 4 and 5, whenever an emergency (e.g., a car accident, a house on fire, an entrapment in a glass-enclosed environment, etc.) takes place, a user holding the flashlight or baton can hit the glass barrier 42 forcefully with the glass breaking cap 4 so that all the force applied by the user to the flashlight or baton is transmitted sequentially through the flashlight or baton to the top portion 41 of the cap 4 and, once the striking portion 410 hits the glass barrier 42, is further transmitted to the glass barrier 42 in a concentrated manner via the tip of the striking portion 410, thereby breaking the internal cohesion of the glass barrier 42 effectively. After that, the glass barrier 42 can be rapidly removed to facilitate rescue operations.

In addition to concentrating the user's striking force, the glass breaking cap 4 is found by experimentation to have the following advantages:

(1) Small volume: As the second included angle θ2 of the striking portion 410 is much smaller than the first included angle θ1 of the top portion 41 of the glass breaking cap 4, the volume of the striking portion 410 is substantially reduced. Consequently, the tip of the striking portion 410 does not extend excessively from the top portion 41 of the cap 4 and is therefore unlikely to injure the user inadvertently while the flashlight or baton equipped with the cap 4 is carried around by the user and swinging along with the user's movement. Also, the small volume of the striking portion 410 lowers both the production cost and weight of the cap 4.

(2) Enhanced breaking effect of the glass breaking cap: With reference to FIG. 5, as the first included angle θ1 of the cap 4 is much larger than the second included angle θ2, the third included angle θ3 is formed between the top portion 41 and the striking portion 410 of the cap 4. Because of the third included angle θ3, once the striking portion 410 creates the breaking point 421 in the glass barrier 42, and the top portion 41 of the cap 4 hits the glass barrier 42, the remaining part of the force applied by the user to the flashlight or baton is transmitted to a portion of the glass barrier 42 that is adjacent to the breaking point 421 to speed up shattering and hence removal of the glass barrier 42.

(3) Dispersal of the reacting force acting on the glass breaking cap: With the top portion 41 of the glass breaking cap 4 tapering upward, the reacting force generated by the glass barrier 42 when the cap 4 hits the glass barrier 42 is transmitted along the first conical projection of the cap 4 and distributed evenly throughout the cap 4. Therefore, even if the user applies an excessively large force when hitting the glass barrier 42 with the cap 4, the striking portion 410 is prevented from deformation. As a result, the durability of the cap 4 is enhanced.

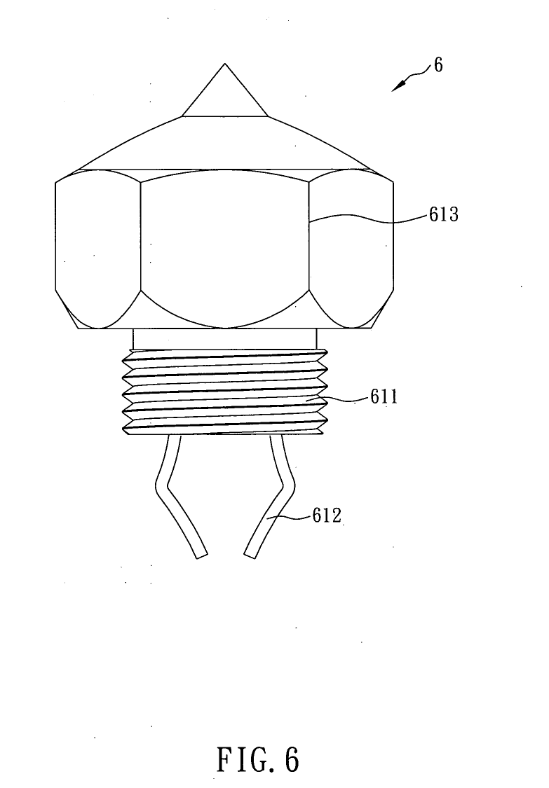

Referring again to FIG. 4, the bottom surface of the glass breaking cap 4 is further provided with a first fastener. In the first preferred embodiment of the present invention, the first fastener takes the form of a threaded bore 411. The threaded bore 411 corresponds in configuration to a second fastener (e.g., a protruding bolt) provided at the end of the flashlight or baton, so that the cap 4 can be connected firmly to the flashlight or baton by means of the threaded bore 411. However, it should be pointed out that the first fastener is not limited to the threaded bore 411 disclosed herein. For example, in the second preferred embodiment of the present invention as shown in FIG. 6, the first fastener is formed as a bolt 611. In this case, the second fastener on the flashlight or baton is formed as a corresponding threaded bore, so as for the glass breaking cap 6 to be fastened to the flashlight or baton. In fact, the first fastener can take any other forms, provided that the first fastener corresponds in configuration to the second fastener on the flashlight or baton and serves to fasten the glass breaking cap to the end of the flashlight or baton.

Referring again to FIG. 6 for the second preferred embodiment of the present invention, in order to facilitate installation of the glass breaking cap 6 on the flashlight or baton, the cap 6 is peripherally and protrudingly provided with a plurality of projecting corners 613. By gripping and turning the projecting corners 613, the user can rotate the cap 6 by its periphery in an intuitive manner, thus increasing the installation convenience of the cap 6. Besides, it is feasible to add two resilient plates 612 to the bolt 611, wherein each resilient plate 612 is resilient and has a curved shape. When the cap 6 is fastened via the bolt 611 to a telescopic baton having multiple sections (not shown), the two resilient plates 612 can be engaged with the inner periphery at one end of the section with the smallest diameter when the telescopic baton is retracted, thereby ensuring that the telescopic baton remains in the retracted state.

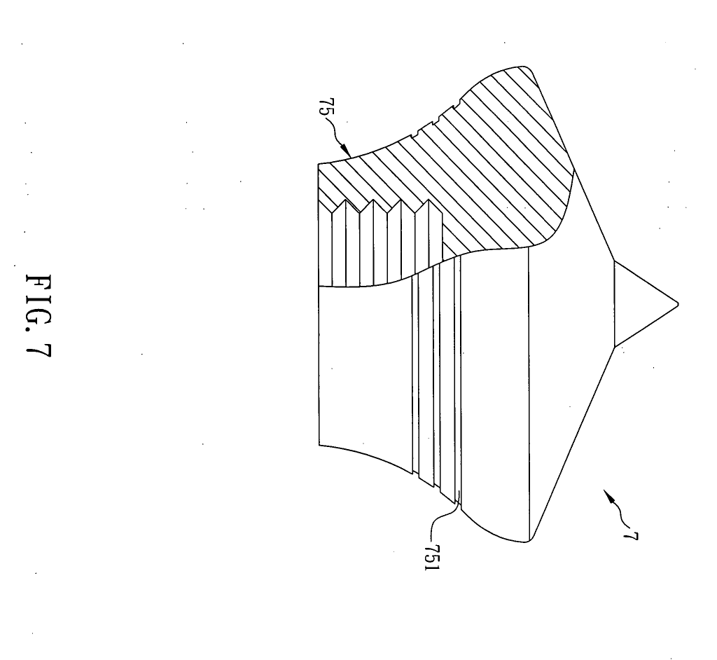

In the third preferred embodiment of the present invention as shown in FIG. 7, the glass breaking cap 7 has a concave peripheral surface 75 adjacent to the bottom surface of the cap 7. The concave peripheral surface 75 converges toward the end of the flashlight or baton so as to connect therewith. In addition, the concave peripheral surface 75 is circumferentially provided with a plurality of grooves 751. Therefore, while the user swings the flashlight or baton in the air, the ulnar side of the hand holding the flashlight or baton can rest on the concave peripheral surface 75. At the meantime, the grooves 751 provide friction between the concave peripheral surface 75 and the ulnar side of the hand so that the flashlight or baton, when swung vigorously or used on a humid day, will not slip off the user's hand.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A glass breaking cap for a flashlight or baton, comprising:
a bottom surface corresponding in configuration to and connectable with an end of the flashlight or baton; and
a top portion tapering upward such that the glass breaking cap has a cross section whose two adjacent upper sides form a first included angle greater than 140 degrees, there being a striking portion extending upward from a central area of the top portion, the striking portion being conical and having a cross section whose two adjacent upper sides form a second included angle less than 100 degrees.

2. The glass breaking cap of claim 1, wherein the bottom surface is provided with a first fastener fastenable to a second fastener provided at the end of the flashlight or baton, so as to connect the glass breaking cap securely to the flashlight or baton.

3. The glass breaking cap of claim 2, wherein the first fastener is a bolt or a threaded bore.

4. The glass breaking cap of claim 1, wherein the glass breaking cap is peripherally and protrudingly provided with a plurality of projecting corners.

5. The glass breaking cap of claim 2, wherein the glass breaking cap is peripherally and protrudingly provided with a plurality of projecting corners.

6. The glass breaking cap of claim 3, wherein the glass breaking cap is peripherally and protrudingly provided with a plurality of projecting corners.

7. The glass breaking cap of claim 1, further comprising a concave peripheral surface adjacent to the bottom surface, the concave peripheral surface having a converging configuration for connecting with the end of the flashlight or baton.

8. The glass breaking cap of claim 2, further comprising a concave peripheral surface adjacent to the bottom surface, the concave peripheral surface having a converging configuration for connecting with the end of the flashlight or baton.

9. The glass breaking cap of claim 3, further comprising a concave peripheral surface adjacent to the bottom surface, the concave peripheral surface having a converging configuration for connecting with the end of the flashlight or baton.

10. The glass breaking cap of claim 7, wherein the concave peripheral surface is circumferentially provided with a plurality of grooves.

11. The glass breaking cap of claim 8, wherein the concave peripheral surface is circumferentially provided with a plurality of grooves.

12. The glass breaking cap of claim 9, wherein the concave peripheral surface is circumferentially provided with a plurality of grooves.
